(19) United States
(12) Patent Application Publication
(10) Pub. No.: US 2006/0176361 A1
(43) Pub. Date: Aug. 10, 2006

(54) Exposing head, luminous amount correction method for the same, and exposing apparatus

(75) Inventor: Yasuhiro Seto, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/350,837

(22) Filed: Feb. 10, 2006

(30) Foreign Application Priority Data
Feb. 10, 2005 (JP) 034433/2005

(51) Int. Cl. G01D 15/14

(52) U.S. Cl. 347/229

(57) ABSTRACT

A luminous amount correction method for an exposing head having a linear luminous element array having a plurality of luminous elements and a lens array having lenses. The method includes the steps of: activating each luminous element uniformly based on a common light emission command signal; measuring luminous amounts of the light outputted from the lens array along the entire length of the array at a photometric pitch not greater than the arrangement pitch of the luminous elements; integrating the luminous amounts for each luminous element with respect to an interval equal to the arrangement pitch; obtaining a luminous amount correction factor for each luminous element based on the integrated luminous amount of each luminous element; and correcting the luminous amount of each luminous element, which is controlled according to an image signal, based on the luminous amount correction factor when performing image exposure.

### BACKGROUND OF THE INVENTION

1. Field of the Invention

The present invention relates to an exposing head that includes a linear luminous element array having a plurality of luminous elements arranged in a line, and a method for correcting the luminous amount of the exposing head at the time of image exposure.

The present invention is also directed to an exposing apparatus that implements the luminous amount correction method described above.

2. Description of the Related Art

Exposing systems for exposing a photosensitive material using an exposing head that includes a linear luminous element array having a plurality of luminous elements arranged in a line are known as described, for example, in U.S. Pat. No. 5,592,205 and Japanese Unexamined Patent Publication No. 2000-013571. Normally, the linear luminous element array is used in combination with a lens array, and the light condensed by the lens array is irradiated on the photosensitive material to be exposed. The lens array is constituted by a plurality of imaging lenses with one-to-one magnification, each for condensing the light emitted from each of the corresponding luminous elements of the linear luminous element array, disposed in a direction substantially parallel to the arrangement direction of the luminous elements.

The exposing system that uses such exposing head further includes a subscanning means for relatively moving a photosensitive material, which is held at the location on which the light emitted from the exposing head is irradiated, with respect to the exposing head in the subscanning direction which is orthogonal to the arrangement direction of the luminous elements of the linear luminous element array (main scanning direction).

In the mean time, if luminous elements, such as organic EL elements or the like, constituting the linear luminous element array, have different luminous properties with each other, the light emitted from respective luminous elements have different luminous amounts with each other even when an identical light emission command signal is given to them. If that is the case, and if an image having several portions which are identical in grayscale level or color tone in the main scanning direction is exposed by the exposing system described above, difference in the grayscale levels or color tones may be developed in those portions. Such difference in the grayscale levels or color tones may extend in an elongated manner and appear as so-called uneven streaks.

A method for eliminating variation in the luminous amount of the light emitted from the linear luminous element array in the long-axis direction of the array is known. In the method, each of the luminous elements of the array is activated uniformly based on a common light emission command signal, and the luminous amount of the light emitted from each of the luminous elements is measured to obtain a luminous amount variation characteristic. Thereafter, luminous amount of each of the luminous elements is corrected such that the variation characteristic is eliminated when the linear luminous element array is actually used.

When performing such luminous amount correction method as described above, it is necessary to accurately measure the luminous amount of each of the luminous elements of the linear luminous element array when activated uniformly. In this respect, a problem of inaccurate measurement of the luminous amount is likely to occur. That is, measurement of the luminous amount of a certain luminous element is influenced by the light emitted from the adjacent luminous elements, since they are arranged so closely with each other. FIG. 1 shows an illustrative example of luminous amount distribution of the light emitted from 8 luminous elements constituting the linear luminous element array and condensed by such a lens array as described above in the longitudinal direction of the lens array at the imaging surface of the lenses. As is shown in FIG. 1, if the bottom section of the luminescence extends to the luminous center of a certain luminous element from the adjacent luminous elements, the luminous amount measured at the luminous center of the luminous element results in a higher value than the actual value due to the added luminescence from the adjacent luminous elements. This tendency becomes more significant, if the luminous elements are arranged closely with each other and the arrangement pitch of the elements becomes very small, which is as close as the minimum beam diameter that the lens may produce.

A method for accurately measuring the luminous amount of each of the luminous elements without being influenced by the light from the adjacent elements is known as described, for example, in Japanese Patent No. 3374687. In the method, a luminous amount detecting sensor having a slit for limiting the light receiving width is placed opposite to multitudes of luminous elements arranged in the main scanning direction, and moved in the main scanning direction. When detecting the luminous amount of each of the luminous elements, the elements are activated in skipped manner so that at least the adjacent elements are deactivated, and the luminous amount of each of the luminous elements is determined based on the output of the sensor. In the method, peak is detected from the output of the scan moving luminous amount detecting sensor to determine the center position of each of the luminous elements, in order to provide correspondence between the detected luminous amount and the luminous element.

The method in which peak of the luminous amount detection signal is detected, and the center position of each luminous element is detected based on the peak detection, however, may cause a problem that the center position of each luminous element is determined incorrectly when a linear luminous element array is used in combination with the lens array described above. Hereinafter, the problem will be described in detail.

Generally, the lens array described above includes a plurality of lens rows, each having a plurality of lenses, such as gradient index lenses or the like, arranged in one direction, and the lens rows are disposed in the direction which is orthogonal to the arrangement direction of the lenses. The adjacent lens rows are disposed such that each of the lenses of one of the lens rows lies at each space between the lenses of the other lens row. That is, the overall arrangement of the lenses looks like a zigzag pattern. When the light emitted from a linear luminous element array is transmitted through such lens array, the luminous amount of the exposing light transmitted through the lens array fluctuates periodically along the long-axis of the lens array (the axis extending in the lens arrangement direction at the center position of the lens row arrangement direction) with the lens arrangement pitch as the period.

For the linear luminous element array placed in alignment with the long-axis of the lens array, i.e., placed such that the light axis of each of the luminous elements is on the long-axis of the lens array, fluctuation in the luminous amount is not so significant, because the fluctuation in the luminous amount is cancelled out by the lenses arranged in a zigzag pattern on both sides of the long-axis. But, for a linear luminous element array placed at a location remote from the long-axis, fluctuation in the luminous amount is significant since such canceling effect is small. Such fluctuation in the luminous amount may develop the uneven streaks described above.

FIG. 2 shows an illustrative example of variation in the luminous amount along the long-axis direction of the lens array developed in the manner as described above. Here, the numeric value appended to each of the curves indicates an offset of the linear luminous element array from the long-axis of the lens array. That is, the curve indicated by the numeric value of ±0 μm is the variation in the luminous amount of the linear luminous element array placed in alignment with the long-axis.

This problem is not limited to the lens array in which the lenses are arranged in a zigzag pattern as described above. It may also arise in a lens array having only a single lens row if the linear luminous element array is placed such that the light axis of each of the lenses is displaced from the long-axis of the lens array (the axis extending in the lens arrangement direction across the light axis of each lens in this case). In this case also, the luminous amount of the exposing light transmitted through the lens array fluctuates periodically along the long-axis of the lens array with the lens arrangement pitch as the period.

Hereinafter, the aforementioned variation in the luminous amount caused by the lens array will be described in detail with reference to FIGS. 3, 4, and 5. FIG. 3 shows an illustrative example of detected luminous amount distribution when each of the luminous elements of the linear luminous element array is activated uniformly with substantially no variation in the luminous amount caused by the lens array. In the present example, the arrangement pitch of the luminous elements is 0.1 mm. Here, the luminous amount detection signal waveform for each luminous element becomes the peak value at the center of each element. In contrast, for example, if a lens array having the luminous amount variation characteristic shown in FIG. 4 is used, the detected luminous amount distribution pattern when each of the luminous elements of the linear luminous element array is activated uniformly becomes like that shown in FIG. 5 by reflecting the luminous amount variation characteristic of the lens array. In the present example, the period of the variation in the luminous amount of the lens array is 0.3 mm.

As FIG. 5 indicates, in the luminous amount detection signal waveform for each of the luminous elements, the top region of certain luminous elements is inclined by reflecting the luminous amount variation characteristic of the lens array. If that is the case, the peak of the waveform of these luminous elements appears at the position which is displaced from the center of these luminous elements. Thus, if the center of each of the luminous elements is determined based on this peak detection method, the center position is recognized incorrectly. If the center position is recognized incorrectly, measurement of the luminous amount for each luminous element results in erroneous, which may lead to inadequate correction of the luminous amount.

So far, the problem found in the exposing head that uses a luminous element array having self-luminous elements such as organic EL elements or the like has been described. This problem is not limited to the self-luminous element array. The similar problem may also be found in the exposing heads that uses a device constituted by light modulation elements, such as a liquid crystal, PLZT, or the like in combination with, a light source. The device constituted by the combination of light modulation elements and a light source is also referred to herein as “luminous element” in the sense that it also emits exposing light.

In view of the circumstances described above, it is an object of the present invention to provide a luminous amount correction method for an exposing head that uses a linear luminous element array in combination with a lens array, which is capable of properly correcting luminous amount of the exposing head by accurately determining variation in the luminous amount along the long-axis of the exposing light array.

It is a further object of the present invention to provide an exposing apparatus in which the luminous amount correction method for an exposing head described above may be implemented, and an exposing head which is suitable for constructing the exposing apparatus.

### SUMMARY OF THE INVENTION

The luminous amount correction method for an exposing head according to the present invention is a method for correcting the luminous amount of an exposing head having a linear luminous element array constituted by a plurality of luminous elements arranged in a line, the luminous amount of each of the luminous elements being controlled independently according to an image signal representing an image to be exposed; and a lens array constituted by a plurality of imaging lenses with one-to-one magnification, each for condensing the light emitted from each of the corresponding luminous elements, arranged in a direction substantially parallel to the arrangement direction of the luminous elements to condense the light emitted from each of the luminous elements on a photosensitive material to be exposed, in which the luminous amount of each of the luminous elements is corrected to eliminate variation in the luminous amount of the light outputted from the lens array in the arrangement direction of the luminous elements, the method comprising the steps of:

activating each of the luminous elements of the linear luminous element array uniformly based on a common light emission command signal;

measuring luminous amounts of the light outputted from the lens array along the entire length of the array at a photometric pitch which is not greater than the arrangement pitch of the luminous elements;

integrating the measured luminous amounts with respect to an interval which is equal to the arrangement pitch of the luminous elements for each of the luminous elements;

obtaining a luminous amount correction factor for each of the luminous elements based on the integrated luminous amount obtained for each of the luminous elements; and

correcting the luminous amount of each of the luminous elements, which is controlled according to the image signal, based on the luminous amount correction factor obtained for each of the luminous elements when exposing the photosensitive material.

For measuring the luminous amounts of the light outputted from the lens array along the entire length of the array at the photometric pitch which is not greater than the arrangement pitch of the luminous elements as described above, an optical receiver that includes a light receiving surface covered with a slit having an aperture with an aperture length not greater than the photometric pitch may be used, in which the optical receiver is moved along the longitudinal direction of the lens array in an intermittent fashion to stop the receiver in photometric pitch at each place for measuring the luminous amount thereat. Alternatively, a light receiving element array constituted by a plurality of light receiving elements, each having a light receiving width not greater than the photometric pitch, disposed in the arrangement direction of the luminous elements may be used for the measurement.

Preferably, in the luminous amount correction method for an exposing head according to the present invention, the photometric pitch for measuring the luminous amount is 1/N (N≧3) of the arrangement pitch of the luminous elements.

The exposing apparatus of the present invention in which the method described above is implemented is an apparatus, comprising: an exposing head having a linear luminous element array constituted by a plurality of luminous elements arranged in a line, the luminous amount of each of the luminous elements being controlled independently according to an image signal representing an image to be exposed; and a lens array constituted by a plurality of imaging lenses with one-to-one magnification, each for condensing the light emitted from each of the corresponding luminous elements, arranged in a direction substantially parallel to the arrangement direction of the luminous elements to condense the light emitted from each of the luminous elements on a photosensitive material to be exposed;

a subscanning means for moving the photosensitive material relative to the exposing head in a direction which is substantially orthogonal to the arrangement direction of the luminous elements;

a storage means storing the luminous amount correction factors; and

a correction means for correcting the luminous amount of each of the luminous elements, which is controlled according to the image signal, based on the luminous amount correction factor read out from the storage means.

In the exposing head according to the present invention, the arrangement pitch of the luminous elements is set to 1/P (P≧2.2) of the diameter of the imaging lenses with one-to-one magnification constituting the lens array when the head is incorporated in the exposing apparatus described above.

According to the luminous amount correction method for an exposing head, each of the luminous elements of the linear luminous element array is activated uniformly based on a common light emission command signal, and the luminous amounts of the light outputted from the lens array is measured along the entire length of the array at a photometric pitch which is not greater than the arrangement pitch of the luminous elements. Then, the measured luminous amounts are integrated with respect to an interval which is equal to the arrangement pitch of the luminous elements for each of the luminous elements, and a luminous amount correction factor for each of the luminous elements is obtained based on the integrated luminous amount obtained for each of the luminous elements. This allows a proper luminous amount correction factor reflecting the luminous amount variation characteristic of the lens array to be obtained for each of the luminous elements. Thus, proper correction for the luminous amount may be implemented for each of the luminous elements using the proper luminous amount correction factor so obtained.

Further, in the method according to the present invention, although correct correspondence in the position of the area for integrating the measured luminous amounts and of the luminous element is required, there is no need to accurately determine the center of each of the luminous elements for measuring the luminous amount. Consequently, even if the luminous amount detection signal waveform of some of the luminous elements are inclined at the top region as described earlier with reference to FIG. 5, the luminous amount of each of the luminous elements may always be measured accurately without being influenced by these inclinations. Thus, the luminous amount may always be corrected accurately.

Still further, as there is no need to accurately determine the center of each of the luminous elements for measuring the luminous amount, a low priced photodetector having a comparatively large light receiving area with high S/N ratio may be used as the photodetector for measuring the luminous amount. Further, as there is no need to accurately determine the center of each of the luminous elements, the time required for measuring the luminous amount may also be reduced.

### BRIEF DESCRIPTION OF THE DRAWINGS

FIG. 1 is a graph illustrating an example of luminous amount distribution of the light emitted from a linear luminous element array in the longitudinal direction of the array.

FIG. 2 is a graph illustrating an example of luminous amount distribution of the light transmitted through a lens array along the long-axis of the array.

FIG. 3 is a graph illustrating an example of detected luminous amount distribution when each of luminous elements of the linear luminous element array is activated uniformly.

FIG. 4 is a graph illustrating an example of luminous amount variation characteristic of the lens array.

FIG. 5 is a graph illustrating an example of detected luminous amount distribution when each of the luminous elements of the linear luminous element array is activated uniformly.

FIG. 6 is a partially broken front elevation view of an organic EL exposing apparatus according to an embodiment of the present invention.

FIG. 7 is a partially broken side view of the aforementioned organic EL exposing apparatus.

FIG. 8 is a partial plan view of a linear luminous element array used for the aforementioned exposing apparatus, illustrating the arrangement thereof.

FIG. 9 is a front elevation view of a photometric means for measuring the luminous amount emitted from the exposing head of the aforementioned exposing apparatus.

FIG. 10 is a plan view of the aforementioned photometric means.

FIG. 11 is a plan view of an alternative photometric means.

FIG. 12 is a graph illustrating an example distribution of the moving average of luminous amount measurement signals.

FIG. 13 is a graph illustrating another example distribution of the moving average of luminous amount measurement signals.

FIG. 14 is a graph illustrating a luminous amount distribution characteristic of the linear luminous element array activated after the luminous amount thereof is corrected.

FIG. 15 is a graph illustrating an example distribution of the moving average of the luminous amount measurement signals after the luminous amount is corrected.

FIG. 16 is a graph illustrating computer simulation results of the relationship between an amount of displacement of the photometric point from the center of the luminous element and luminous amount correction capability for a plurality of cases in which the photometric pitch is changed for each case.

FIG. 17 is a graph illustrating computer simulation results of the relationship between the ratio of luminous element pitch to photometric pitch and luminous amount correction capability.

FIG. 18 is a graph illustrating computer simulation results of the relationship between an amount of displacement of the photometric point from the center of the luminous element and luminous amount correction capability for a plurality of cases in which photometric aperture length is changed in each case.

FIG. 19 is a graph illustrating the relationship between the ratio of the lens diameter of the lens array to the element pitch of a linear luminous element and luminous amount correction capability.

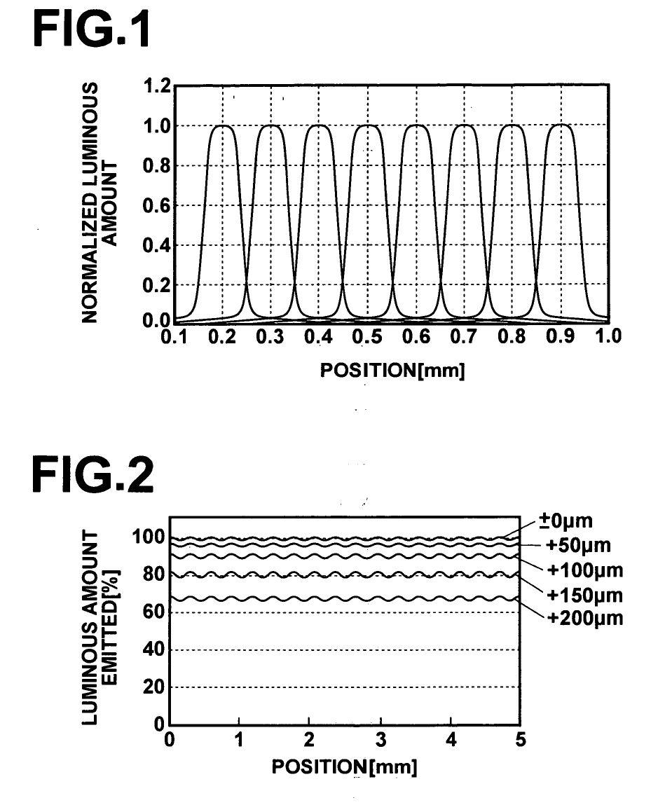

### DESCRIPTION OF THE PREFERRED EMBODIMENTS

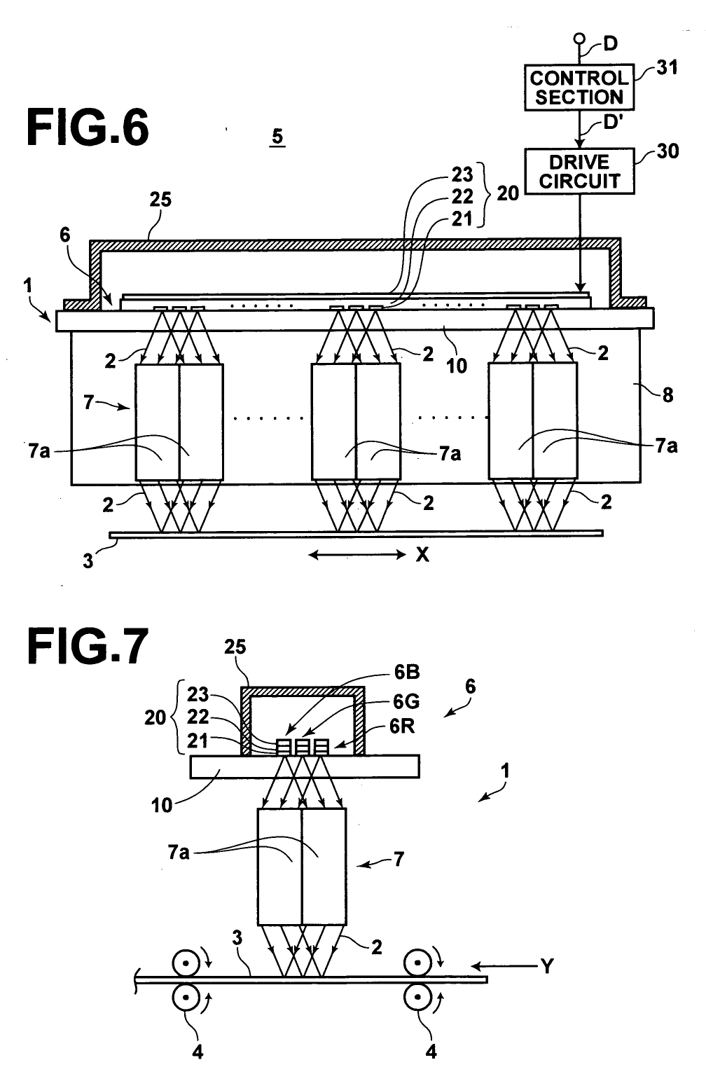

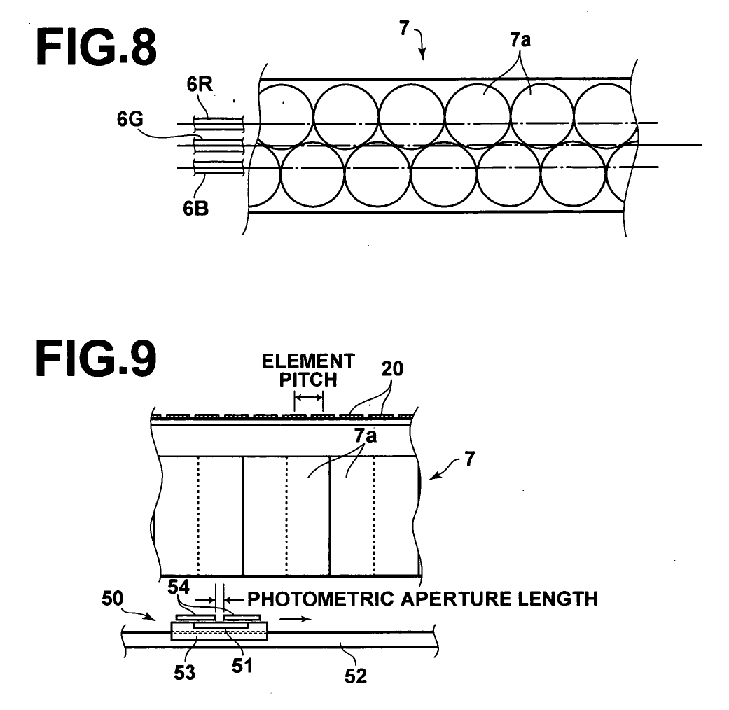

Hereinafter, embodiments of the present invention will be described with reference to the accompanying drawings. FIGS. 6 and 7 are partially broken front elevation view and partially broken side view of an organic EL exposing apparatus 5 respectively according to an embodiment of the present invention. FIG. 8 is a plan view of a lens array 7 used for the exposing apparatus 5.

First, the basic structure of the organic EL exposing apparatus 5 will be described with reference to FIGS. 6 to 8. As shown in the drawings, the exposing apparatus 5 includes an exposing head 1 and a subscanning means 4, such as nip rollers or the like, for feeding a color photosensitive material 3 which is held at the position where exposing light 2 emitted from the exposing head 1 is irradiated, in the direction indicated by the allow Y in FIG. 7 at a constant speed.

The exposing head 1 includes an organic EL panel 6, a gradient index lens array 7 placed at the position where exposing light 2 emitted from the organic EL panel 6 is irradiated to focus an image represented by the exposing light 2 on the color photosensitive material 3 at the same magnification, and a holding means 8 (not shown) for holding the lens array 7 and organic EL panel 6.

The gradient index lens array 7, which is a one-to-one magnification lens array, includes two lens rows, each having multitudes of tiny gradient index lenses 7a arranged in the main scanning direction (arrow X direction), which is orthogonal to the subscanning direction Y, for condensing the exposing light 2 as elaborated in FIG. 8 of a plan view thereof. In the gradient index lens array 7, the gradient index lenses are arranged in a zigzag pattern. That is, a plurality of gradient index lenses 7a constituting one of the lens rows are arranged such that each of the lenses lies between every two lenses of a plurality of gradient index lenses 7a constituting the other lens row.

The exposing apparatus 5 of the present embodiment is an apparatus for exposing a color image on the color photosensitive material 3 which is, for example, a full color positive silver salt photosensitive material. The organic EL panel 6 constituting the exposing head 1 includes a linear red luminous element array 6R, a linear green luminous element array 6G, and a linear blue luminous element array 6B arranged in the subscanning direction Y. These linear luminous element arrays 6R, 6G, and 6B have multitudes of red organic EL elements, green organic EL elements, and blue organic EL elements arranged in the main scanning direction respectively.

In FIGS. 6 and 7, one of the luminous elements representing all of the elements is indicated as an organic EL element 20. Each of the organic EL elements 20 includes transparent positive electrodes 21, an organic compound layer 22 having a luminous layer, and metal negative electrodes 23 layered in this order by deposition method on a transparent substrate 10 made of glass or the like. A red organic EL element, a green organic EL element, and a blue organic EL element are formed respectively by applying a layer that emits red, green, or blue light as the luminous layer.

The linear luminous element arrays 6R, 6G, and 6B are driven by a drive circuit 30 shown in FIG. 6. That is, the drive circuit 30 includes a negative electrode driver for sequentially activating the metal negative electrodes 23 acting as the scanning electrode at a predetermined period, and a positive electrode driver for activating the transparent positive electrodes 21 acting as the signal electrode based on image data D that represents a full color image. The drive circuit 30 drives the linear luminous element arrays 6R, 6G, and 6B based on a so-called passive matrix line sequential driving method. The operation of the drive circuit 30 is controlled by a control section 31 that corrects the image data D and outputs the corrected image data as image data D′. The correction of the image data D will be described in detail later.

The elements constituting each of the organic EL elements 20 are installed in a sealing member 25, such as a stainless steel can or the like. That is, the edge portion of the sealing member 25 is bonded to the transparent substrate 10, and the organic EL element 20 is sealingly installed in the interior of the sealing member 25 with dried nitrogen gas being filled therein.

In the organic EL element constructed in the manner as described above, when a voltage is applied between one of the metal negative electrodes 23 and one of the transparent positive electrodes extending transversally to the negative electrodes 23, a current flows in the organic compound layer 22 at the intersection between the electrodes where the voltage is applied, and the luminous layer included therein emits light. The light emitted in the manner as described above transmits through the transparent positive electrodes 21 and the transparent substrate 10, and exits from the element as exposing light 2.

Preferably, the transparent positive electrodes 21 have a light transmittance of at least 50%, more preferably at least 70% for the wavelength region of visible light from 400 nm to 700 nm. As for the material of the transparent positive electrodes 21, known compounds used as the materials for transparent electrodes including tin oxide, indium tin oxide (ITO), indium zinc oxide, or the like may be used as appropriate. In addition, a thin film made of gold or platinum having a high work function may also be used. Further, organic compounds, such as polyaniline, polythiophene, polypyrrole, and the derivatives of those materials may also be used. Still further, the transparent conductive film described in detail in the book entitled “Developments of Transparent Conductive Films”, edited by Yutaka Sawada, CMC Corporation, 1999 may also be applied to the present invention. The transparent positive electrodes 21 may be formed on the transparent substrate 10 by vacuum deposition method, sputtering method, ion plating method, or the like.

In the mean time, the organic compound layer 22 may have a single layer structure constituted only by the luminous layer, or a multi-layer structure constituted by a hole injection layer, a hole transport layer, an electron injection layer, electron transport layer, and the like in addition to the luminous layer. As for the detailed structure of the organic compound layer 22 and the electrodes, a structure in which the positive electrodes/hole injection layer/hole transport layer/luminous layer/electron transport layer/negative electrodes are arranged in this order is possible. Alternatively, a structure in which the positive electrodes/luminous layer/electron transport layer/negative electrodes are arranged in this order, or a structure in which the positive electrodes/hole transport layer/luminous layer/electron transport layer/negative electrodes are arranged in this order, or the like is also possible. Further, a plurality of luminous layers, hole transport layers, hole injection layers, or electron injection layers may be provided.

Preferably, the metal negative electrodes 23 are made of an alkali metal, such as Li, K, or the like having a low work function, an alkali earth metal, such as Mg, Ca, or the like, or a metal material inclduing an alloy or compound composed of one of Ag, Al, and the like and one of the aforementioned metals. In order to balance the preservation stability of the negative electrodes and ease of electron injections, the electrodes made of the aforementioned material may further be coated with Ag, Al, Au, or the like having a high work function and high conductivity. The metal negative electrodes 23 may be formed by a known method, such as the vacuum deposition method, sputtering method, ion plating method, or the like, as with the transparent positive electrodes 21.

Hereinafter, the operation of the exposing apparatus 5 constructed in the manner as described above will be described. Here, the number of pixels of the linear luminous element arrays 6R, 6G, and 6B in the main scanning direction, i.e., the number of parallel transparent positive electrodes 21 is assumed to be “n”. When exposing an image on the color photosensitive material 3, the color photosensitive material 3 is moved by a subscanning means 4 in the direction indicated by the arrow Y at a constant speed. In synchronization with the feeding of the color photosensitive material 3, one of the three metal negative electrodes 23 is sequentially selected in on-state by the negative electrode driver of the drive circuit 30.

While the first metal negative electrode 23, i.e., the metal negative electrode 23 constituting the linear red luminous element array 6R is selected in this way, each of the transparent positive electrodes 21 ranging from the first to n^{th} electrodes is connected to a constant current source by the positive electrode driver of the drive circuit 30 for a time period that corresponds to each of the red color densities of the first to n pixels in the first main scanning line indicated by the image data D (correction may be made to the time period described above, which will be described later). Consequently, a pulse current having a pulse width corresponding to the image data flows in each portion of the organic compound 22 (FIG. 6) between each of the transparent positive electrodes 21 and the metal negative electrode 23. In this way, red light is emitted from the organic compound layer 22.

The exposing light 2 which is the red light emitted from the linear red luminous element array 6R in the manner as described above is focused on the color photosensitive material 3 by a lens array 7, thereby the pixels ranging from the first to n^{th} pixels constituting the first main scanning line on the color photosensitive material 3 are exposed by the red light and turn colored in red according to the image data.

Then, while the second metal negative electrode 23, i.e., the metal negative electrode 23 constituting the linear green luminous element array 6G is selected, each of the transparent positive electrodes 21 ranging from the first to n^{th} electrodes is connected to a constant current source by the positive electrode driver of the drive circuit 30 for a time period that corresponds to each of the green color densities of the first to n^{th} pixels in the first main scanning line indicated by the image data D. Consequently, a pulse current having a pulse width corresponding to the image data flows in each portion of the organic compound 22 (FIG. 6) between each of the transparent positive electrodes 21 and the metal negative electrode 23. In this way, green light is emitted from the organic compound layer 22.

The exposing light 2 which is the green light emitted from the linear green luminous element array 6G in the manner as described above is focused on the color photosensitive material 3 by a lens array 7, thereby the pixels ranging from the first to n^{th} pixels constituting the first main scanning line on the color photosensitive material 3 are exposed by the green light and turn colored in green according to the image data. Here, the green light is irradiated on the upper side of the color photosensitive material 3 already exposed by the red light, since the color photosensitive material 3 is moved at a constant speed as described earlier.

Then, while the third metal negative electrode 23, i.e., the metal negative electrode 23 constituting the linear blue luminous element array 6B is selected, each of the transparent positive electrodes 21 ranging from the first to n^{th} electrodes is connected to a constant current source by the positive electrode driver of the drive circuit 30 for a time period that corresponds to each of the blue color densities of the first to n^{th} pixels in the first main scanning line indicated by the image data D. Consequently, a pulse current having a pulse width corresponding to the image data flows in each portion of the organic compound 22 (FIG. 6) between each of the transparent positive electrodes 21 and the metal negative electrode 23. In this way, blue light is emitted from the organic compound layer 22.

The exposing light 2 which is the blue light emitted from the linear green luminous element array 6B in the manner as described above is focused on the color photosensitive material 3 by a lens array 7, thereby the pixels ranging from the first to n^{th} pixels constituting the first main scanning line on the color photosensitive material 3 are exposed by the blue light and turn colored in blue according to the image data. As the color photosensitive material 3 is moved at a constant speed as described above, the blue light is irradiated on the upper side of the color photosensitive material 3 already exposed by the red and green light. Through the process described above, a first full color main scanning line is exposed and recorded on the color photosensitive material 3.

Thereafter, sequential metal negative electrode selection process returns to the first metal negative electrode 23, and while the first metal negative electrode 23, i.e., the metal negative electrode 23 constituting the linear red luminous element array 6R is selected, each of the transparent positive electrodes 21 ranging from the first to n^{th} electrodes is connected to a constant current source by the positive electrode driver of the drive circuit 30 for a time period that corresponds to each of the red color densities of the first to n^{th} pixels in the second main scanning line indicated by the image data D. Consequently, a pulse current having a pulse width corresponding to the image data flows in each portion of the organic compound 22 (FIG. 6) between each of the transparent positive electrodes 21 and the metal negative electrode 23. In this way, red light is emitted from the organic compound layer 22.

The exposing light 2 which is the red light emitted from the linear red luminous element array 6R in the manner as described above is focused on the color photosensitive material 3 by a lens array 7, thereby the pixels ranging from the first to n^{th} pixels constituting the second main scanning line on the color photosensitive material 3 are exposed by the red light and turn colored in red according to the image data.

Then, the similar process is repeated to expose a second full color main scanning line. Thereafter, such full color main scanning line is exposed and arranged one after another in the subscanning direction Y, and a two-dimensional color image constituted by multitudes of the main scanning lines is exposed on the color photosensitive material 3. In the present embodiment, each color exposing light is modulated through pulse duration modulation as described above, and the luminous amount is controlled according to the image data, thereby a color gradation image is exposed.

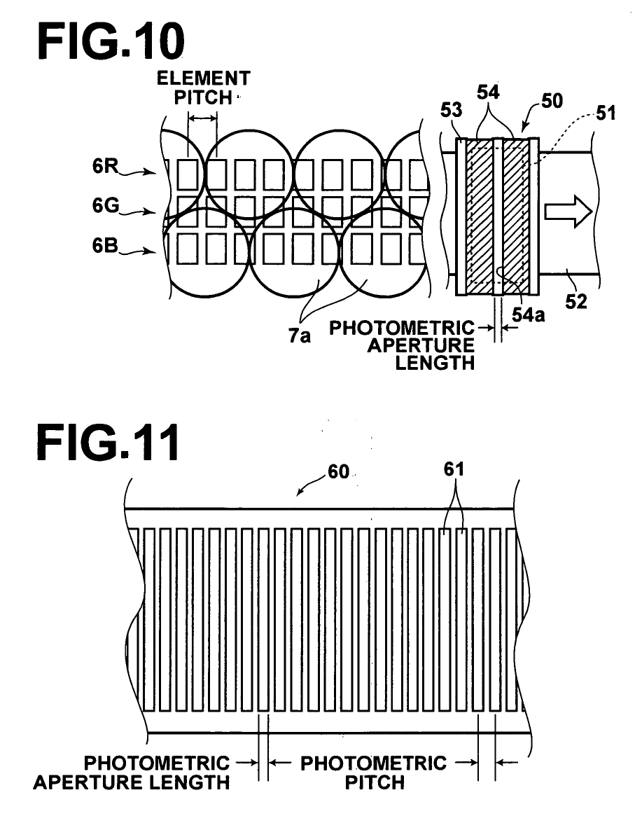

Hereinafter, a method for preventing the uneven streaks described earlier from developing in an exposed image due to variation in the luminous property of the organic EL elements 20, or variation in the luminous amount of the lens array 7. The exposing apparatus of the present embodiment is subjected to a photometric process for correcting the luminous amount of the exposing head prior to performing the image exposure described above. FIGS. 9 and 10 are front elevation view and plan view of a photometric means respectively. As shown in the drawings, the photometric means 50 includes an optical receiver 51 which is placed at the position where the color photosensitive material 3 is placed at the time of image exposure, a moving means 53 holding the optical receiver 51 and is mounted on a guide 52, and a light blocking member 54 for covering the light receiving surface of the optical receiver 51 such that only a part of the light receiving surface is exposed.

The moving means 53 is movably formed in an intermittent fashion in the arrangement direction of the lenses 7a of the lens array 7 along the guide 52. In the present embodiment, the arrangement pitch (element pitch) of the organic EL elements 20 of the linear luminous element arrays 6R, 6G and 6B is 100 μm, whereas the intermittent motion pitch (photometric pitch) of the moving means 53 is 10 μm which is 1/10 of the element pitch. The light blocking member 54 has an elongated slit 54a extending in the direction which is orthogonal to the moving direction of the moving means 53, and only a part of the light receiving surface of the optical receiver 51 is exposed through the slit 54a. The width of the slit 54a, i.e., the photometric aperture length is 10 μm, which is equal to the photometric pitch.

When a photometric process is performed, initially the moving means 53 is positioned at one of the ends of the guide 52. Then, for example, a certain amount of current is supplied to each of the organic EL elements 20 of the linear red luminous element array 6R based on a common light emission command signal, and each of the organic EL elements 20 is activated uniformly. Then, the moving means 53 is moved in the intermittent fashion as described above, and the luminous amount of the light exiting from the lens array 7 is measured by the optical receiver 51 every time the moving means 53 makes a stop. The luminous amount measurement signals outputted from the optical receiver 51 are inputted to the control section 31 shown in FIG. 6.

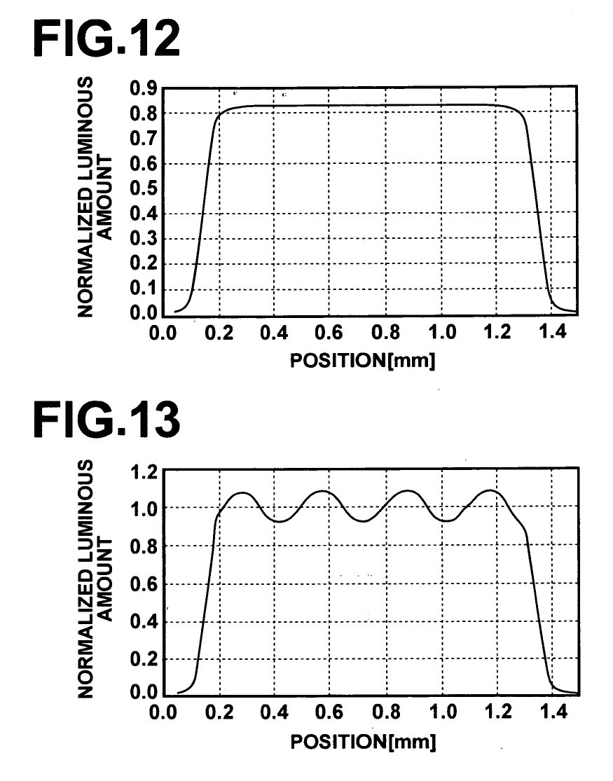

Instead of performing the photometry by moving the optical receiver 51 in the intermittent fashion as described above, a light receiving element array 60 constituted by elongated light receiving elements 61 disposed in the arrangement direction of the organic EL elements 20 shown in FIG. 11 may also be used. In this case, the width of the light receiving element 61 corresponds to the photometric aperture length, and the arrangement pitch of the light receiving elements 61 corresponds to the photometric pitch.

The control section 31 shown in FIG. 6 integrates the luminous amount measurement signals inputted from the optical receiver 51 with respect to an interval which is equal to the arrangement pitch of the luminous elements for each of the EL elements 20. More specifically, in the present embodiment, the control section 31 sums up the luminous amounts at ten photometric points for a single organic EL element 20, five of which locating on one side of the center of the element in the main scanning direction and the other five locating on the other side. Then, the total sum of the luminous amount is multiplied by 1/10 to obtain the average (moving average) which is assumed to be the integrated value for the organic EL element 20.

Here, accurate determination of the center of the organic EL element 20 is not required. All that is required is to ascertain if the ten photometric points are distributed evenly five to five on the left and right sides of the center of the organic EL element in question. For that purpose, for example, the luminous element center may be assumed to lie between a measuring point A where a maximum value is obtained and a measuring point B which is one of the two measuring points adjacent to the measuring point A where a greater value is obtained than the other. Luminous amount obtained at total ten measuring points, i.e., five measuring points ranging on the opposite side of the luminous element center from the measuring point A (inclusive of the measuring point A), and five measuring points ranging on the opposite side of the luminous element center from the measuring point B (inclusive of the measuring point B) may be used for calculating the moving average.

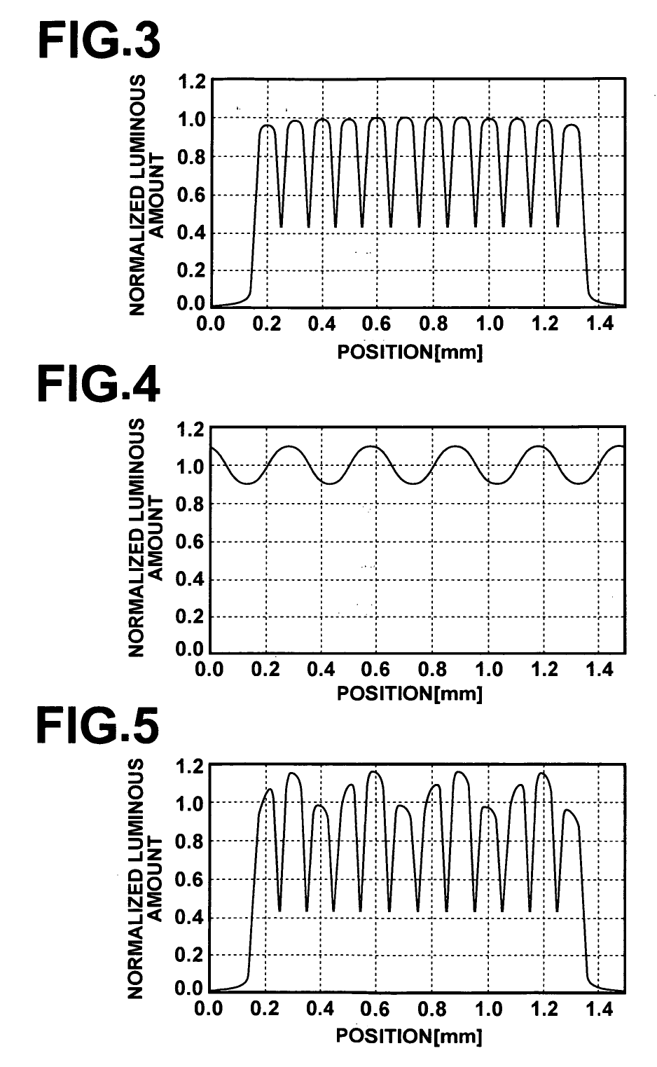

If there is no variation in the luminous property among all of the organic EL elements, for example, of the linear red luminous element array 6R, and the lens array 7 has no variation in the luminous amount, then the distribution of the luminous amount measurement signals outputted from the optical receiver 51 is like that shown in FIG. 3. If a line joining the moving averages obtained at that time is smoothed out, the result is like that shown schematically in FIG. 12. On the other hand, if there is no variation in the luminous property among all of the organic EL elements of the linear red luminous element array 6R, but the lens array 7 has the luminous amount variation characteristic shown in FIG. 4, the distribution of the luminous amount measurement signals outputted from the optical receiver 51 is like that shown in FIG. 5. If a line joining the moving averages obtained at that time is smoothed out, the result is like that shown schematically in FIG. 13.

The characteristic shown in FIG. 13 is a combined characteristic of the luminous property of the linear red luminous element array 6G and the luminous amount variation characteristic of the lens array 7. The control section 31 obtains a luminous amount correction factor for each of the organic EL elements 20 based on the characteristic shown in FIG. 13. The luminous amount correction factor is, for example, a value obtained by dividing a certain fixed value by the value for each EL element 20 in the characteristic described above. Each of the luminous amount correction factors is stored in a memory provided in the control section 31 with each of the corresponding organic EL elements 20 being linked thereto.

When an image exposure is performed based on the image data D as described earlier, image data D for causing a certain organic EL element 20 of the linear red luminous element array 6R to emit light is multiplied by the luminous amount correction factor for the organic EL element 20 by the control section 31 to obtain corrected data D′. The corrected data D′ so obtained is inputted to the drive circuit 30, and the luminous amount of each of the organic EL elements is controlled based on the corrected data D′.

So far, the luminous amount correction method for the linear red luminous element array 6R has been described. The identical processes for obtaining luminous amount correction factors and for correcting luminous amount are performed for the linear green luminous element array 6G and linear blue luminous element array 6B. Consequently, the luminous amount of each of the organic EL elements 20 of the linear luminous element arrays 6R, 6G, and 6B at the time of image exposure is compensated such that the luminous amount variation characteristic like that shown in FIG. 13 is eliminated. Thus, uneven streaks arising from the luminous amount variation characteristic are prevented from developing on an exposed image.

The process for obtaining the luminous amount correction factor for each of the organic EL elements may be performed, for example, prior to factory shipment of the exposing apparatus, and each of the correction factors so obtained is stored in a storage means provided in the control section 31 with each of the corresponding organic EL elements 20 being linked thereto. Thereafter, when the exposing apparatus is actually used, the image data D may be corrected based on the luminous amount correction factors stored in the storage means. Further, the photometric means 50 or the like maybe incorporated in the exposing apparatus in advance, and the process for obtaining the luminous amount correction factors may be performed at appropriate time intervals after the apparatus is put into practical use to successively update the correction factors. This approach allows better response to changes with time in the luminous property of each of the organic EL elements 20, and thereby more accurate correction in the luminous amount may be implemented.

The image data D are the data for controlling the emission time of each of the organic EL elements 20 as described above. It is also possible to control the luminous amount of each of the organic EL elements 20 by controlling the drive voltage or current for each of the organic EL elements 20 based on the image data D. The present invention is also applicable to the latter case. Further, such image data D may be directly inputted to the drive circuit 30, instead of correcting them to corrected image data D′ before inputting to the drive circuit 30, and the emission time, drive voltage, drive current, or the like for each of the organic EL elements 20 indicated by the image data D may be corrected within the drive circuit 30 based on the luminous amount correction factor.

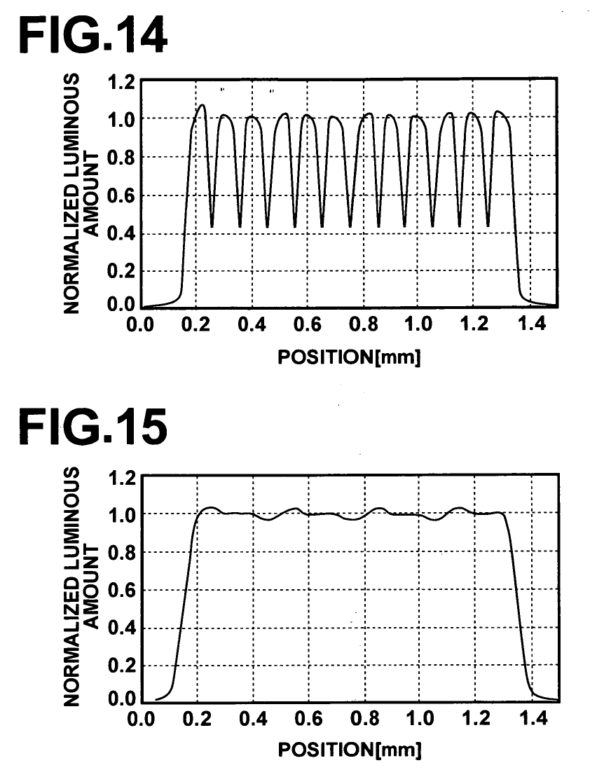

FIG. 14 shows an illustrative example of luminous amount distribution characteristic of the light emitted from all of the organic EL elements 20 based on corrected data D′ when all of the organic EL elements 20 of the linear red luminous element array 6R are directed to be activated uniformly by the image data D. Here, the moving average distribution is like that schematically shown in FIG. 15, which is closer to that shown in FIG. 12.

Hereinafter, a preferable value for the photometric pitch in the luminous amount correction method for the exposing head according to the present invention will be described. In the embodiment described above, the arrangement pitch (element pitch) of the organic EL elements 20 of the linear luminous element arrays 6R, 6G and 6B is 100 μm and the intermittent motion pitch (photometric pitch) of the moving means 53 is 10 μm which is 1/10 of the element pitch. Here, the photometric pitch is assumed to be 1/N of the element pitch to carry forward the discussion. In the embodiment described above, N is equal to 4. In other embodiments, without changing the element pitch of 100 μm, the photometric pitch is set to 25 μm, i.e., N=4 and to 50 μm, i.e. N=2 respectively to perform the similar correction of the luminous amount.

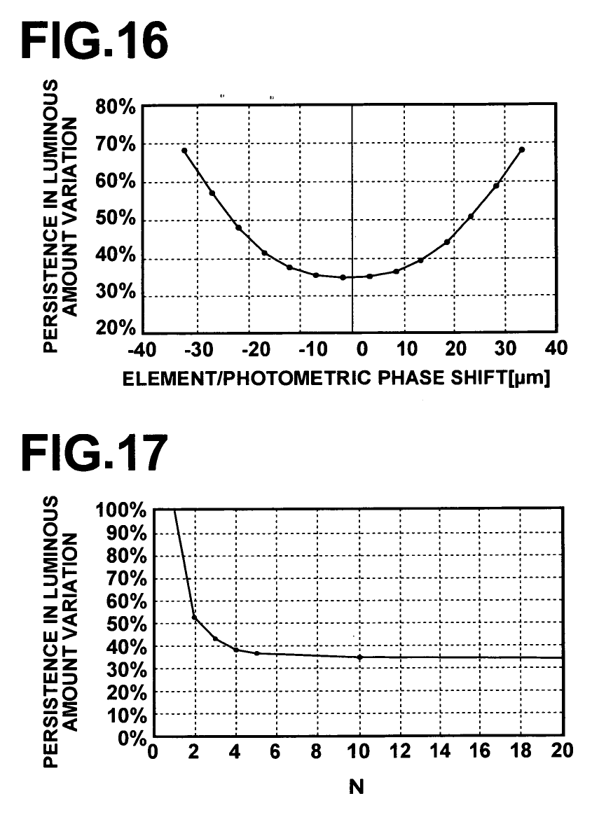

Computer simulation results of the relationship between displaced amounts of photometric point from the center of the luminous element and luminous amount correction capability for these three cases are shown in FIG. 16. The correction capability indicated by the vertical axis is the persistence in the luminous amount variation, i.e. the ratio of the persisting variation in the luminous amount after correction to that before correction expressed by percentage. By definition, it is said that the smaller the ratio, the greater the correction capability. In FIG. 16, the correction capability curves overlap with each other and appear as a single curve. This indicates that the photometric pitch has no direct impact on the correction capability.

Although the photometric pitch has no direct impact on the correction capability as described above, the amount of displacement of the photometric point from the center of the luminous element becomes ±½ of the photometric pitch at maximum. Therefore, a coarser photometric pitch results in a greater amount of displacement of the photometric point from the center of the luminous element, thereby the correction capability is declined. Computer simulation results of the changes in the correction capability are shown in FIG. 17. Here, the computer simulation results of seven cases, namely, N=1 (photometric pitch: 100 μm), N=2 (photometric pitch: 50 μm), N=3 (photometric pitch: 33 μm), N=4 (photometric pitch: 25 μm), N=5 (photometric pitch: 20 μm), N=10 (photometric pitch: 10 μm), and N=20 (photometric pitch: 5 μm) are shown. As is indicated in the graph, the correction capability declines rapidly from around or below N=3. From this, it is said that N is preferable to be not less than 3, i.e., the photometric pitch is preferable to be not greater than ⅓ of the element pitch. In the actual computation for the correction, the integrated luminous amount is obtained for each of the luminous elements by integrating the photometric values with respect to an interval which is equal to the element pitch so that the value of N is preferable to be an integer or a value which is close to an integer.

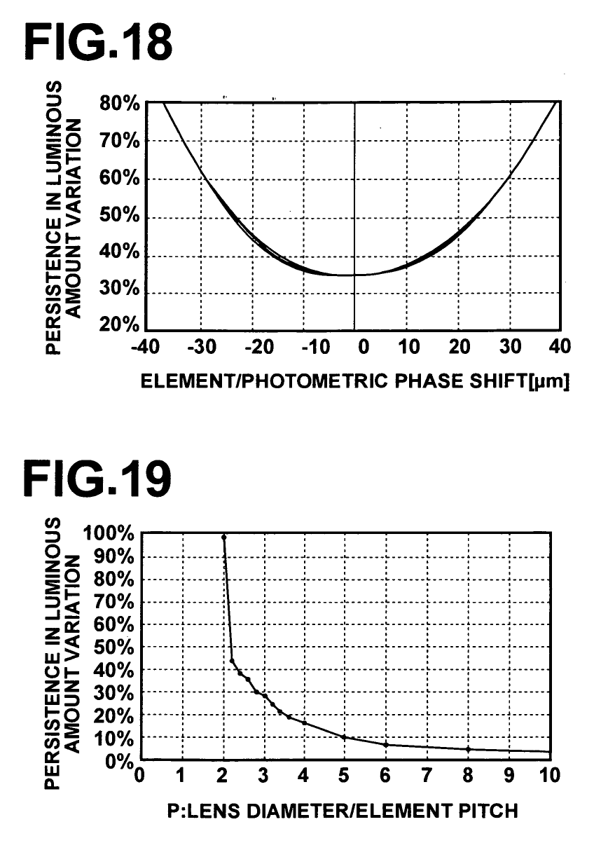

In all of the examples described above, the photometric aperture length (FIG. 10) is set equal to the photometric pitch. But it is not necessarily set equal to the photometric pitch. In particular, where the light receiving element array 60 shown in FIG. 11 is used, it is impossible to arrange a plurality of light receiving elements without any gap between the elements. Consequently, the photometric aperture length becomes smaller than the photometric pitch. In view of this, computer simulations for the correction capability were conducted by changing the photometric aperture length from 10 though 15, 20 to 25 μm under the conditions in which the element pitch and photometric pitch were fixed to 100 μm and 25 μm (N=4) respectively. The results are shown in FIG. 18. In the drawing, the correction capability curves for four examples overlap with each other and appear as a single curve. This indicates that the photometric aperture length has no direct impact on the correction capability.

Hereinafter, a preferable relationship between the diameter of each of the lenses constituting a lens array and the element pitch. Computer simulations were conducted for a lens array and linear luminous element arrays each having a basic structure which is identical to that of the lens array 7 and of the linear luminous element arrays 6R, 6G, and 6B shown in FIGS. 6 to 8 respectively to see how the correction capability changes when a value P, which is obtained by dividing the lens diameter by the element pitch (P=lens diameter/element pitch), is changed to various values. The results are shown in FIG. 19. As is indicated in the graph, the correction capability declines rapidly from around or below P=2.2. Consequently, in the present invention, it is preferable that the value P (P=lens diameter/element pitch) is not smaller than 2.2.

The exposing apparatus according to the embodiment described above is an exposing apparatus for exposing an image on the color photosensitive image 3, which is a full color positive silver salt photosensitive material, using linear luminous element arrays constituted by organic EL elements. But, the exposing apparatus of the present invention may also be constructed to expose an image on a color photosensitive material other than the full color positive silver salt photosensitive material. Further, the linear luminous element array is not limited to that constituted by organic EL elements, and the exposing apparatus of the present invention may also use a linear luminous element array constituted by luminous elements other that the organic EL elements.

What is claimed is:

1. A luminous amount correction method for an exposing head having a linear luminous element array constituted by a plurality of luminous elements arranged in a line, the luminous amount of each of the luminous elements being controlled independently according to an image signal representing an image to be exposed; and a lens array constituted by a plurality of imaging lenses with one-to-one magnification, each for condensing the light emitted from each of the corresponding luminous elements, arranged in a direction substantially parallel to the arrangement direction of the luminous elements to condense the light emitted from each of the luminous elements on a photosensitive material to be exposed, in which the luminous amount of each of the luminous elements is corrected to eliminate variation in the luminous amount of the light outputted from the lens array in the arrangement direction of the luminous elements, the method comprising the steps of:
activating each of the luminous elements of the linear luminous element array uniformly based on a common light emission command signal;
measuring luminous amounts of the light outputted from the lens array along the entire length of the array at a photometric pitch which is not greater than the arrangement pitch of the luminous elements;
integrating the measured luminous amounts with respect to an interval which is equal to the arrangement pitch of the luminous elements for each of the luminous elements;
obtaining a luminous amount correction factor for each of the luminous elements based on the integrated luminous amount obtained for each of the luminous elements; and
correcting the luminous amount of each of the luminous elements, which is controlled according to the image signal, based on the luminous amount correction factor obtained for each of the luminous elements when exposing the photosensitive material.

2. The method according to claim 1, wherein the photometric pitch is set at 1/N (N≧3) of the arrangement pitch of the luminous elements.

3. The method according to claim 1, wherein the luminous amount of each of the luminous elements is controlled by adjusting the emission time thereof.

4. The method according to claim 1, wherein the luminous amount of each of the luminous elements is controlled by adjusting the drive voltage or drive current thereof.

5. The method according to claim 1, wherein the step for obtaining the luminous amount correction factor for each of the luminous elements is performed at appropriate time intervals during a lifetime of the exposing head, and every time a new luminous amount correction factor is obtained, the corresponding luminous amount correction factor is replaced by the new luminous amount correction factor for use in the correction of the luminous amount.

6. The method according to claim 1, wherein the luminous amounts outputted from the lens array is measured by a single optical receiver that moves in an intermittent fashion in the arrangement direction of the luminous elements.

7. The method according to claim 1, wherein the luminous amounts outputted from the lens array is measured by a light receiving element array constituted by light receiving elements disposed in the arrangement direction of the luminous elements.

8. The method according to claim 1, wherein the integrated luminous amount is obtained for each of the luminous elements as a value obtained by dividing a total value of luminous amounts measured at a plurality of photometric points ranging on one side and at a plurality of photometric points ranging on the other side of each of the luminous elements in the arrangement direction of the luminous elements by the total number of the photometric points.

9. An exposing apparatus in which the method according to claim 1 is implemented, the apparatus comprising:
an exposing head having a linear luminous element array constituted by a plurality of luminous elements arranged in a line, the luminous amount of each of the luminous elements being controlled independently according to an image signal representing an image to be exposed; and a lens array constituted by a plurality of imaging lenses with one-to-one magnification, each for condensing the light emitted from each of the corresponding luminous elements, arranged in a direction substantially parallel to the arrangement direction of the luminous elements to condense the light emitted from each of the luminous elements on a photosensitive material to be exposed;
a subscanning means for moving the photosensitive material relative to the exposing head in a direction which is substantially orthogonal to the arrangement direction of the luminous elements;
a storage means storing the luminous amount correction factors; and
a correction means for correcting the luminous amount of each of the luminous elements, which is controlled according to the image signal, based on the luminous amount correction factor read out from the storage means.

10. An exposing head comprising the exposing apparatus according to claim 9, wherein the arrangement pitch of the luminous elements is 1/P (P≧2.2) of the diameter of the lenses.

11. An exposing head comprising the exposing apparatus according to claim 9, wherein the luminous elements are self-luminous elements.

12. The exposing head according to claim 11, wherein the luminous elements are organic EL elements.

13. An exposing head comprising the exposing apparatus according to claim 9, wherein the luminous elements are constituted by a combination of a light source and light modulating elements.

14. An exposing head comprising the exposing apparatus according to claim 9, wherein a plurality of the linear luminous element arrays is disposed in a direction which is substantially orthogonal to the arrangement direction of the luminous elements.

15. The exposing head according to claim 14, wherein linear luminous element arrays for respectively emitting red, green, and blue light are used as the plurality of the luminous element arrays to allow exposure of a full color image on the photosensitive material.
